(19) United States
(12) Patent Application Publication
(10) Pub. No.: US 2014/0295861 A1
(43) Pub. Date: Oct. 2, 2014

(54) NETWORK SYSTEM AND RESOURCE ALLOCATION METHOD THEREOF

(71) Applicant: Institute For Information Industry, Taipei (TW)

(72) Inventors: Chun-Che CHIEN, Taipei City (TW); Shiann-Tsong SHEU, Taipei City (TW); Youn-Tai LEE, New Taipei City (TW); Tsung-Yu TSAI, Tainan City (TW); Yi-Hsueh TSAI, New Taipei City (TW); Chiu-Wen CHEN, Taipei City (TW)

(73) Assignee: Institute For Information Industry, Taipei (TW)

(21) Appl. No.: 14/231,712

(22) Filed: Mar. 31, 2014

Related U.S. Application Data
(60) Provisional application No. 61/806,948, filed on Apr. 1, 2013.

(51) Int. Cl. H04W 74/00

(52) U.S. Cl. CPC H04W 74/00
USPC 455/450

(57) ABSTRACT

A network system and a resource allocation method thereof are provided. The network system includes a base station and a mobile station. The base station retrieves mobile station information from the mobile station via a network connection, and decides a communication allocation between the base station and the mobile station according to the mobile information. The communication allocation records one or a combination of a common base station identification and a dedicated base station identification. After the base station transmits the communication allocation to the mobile station, the mobile station communicates with the base station according to the communication allocation via one or a combination of the common base station identification and the dedicated base station identification.

### PRIORITY

This application claims the benefit of U.S. Provisional Application Ser. No. 61/806,948 filed on Apr. 1, 2013, which is hereby incorporated by reference in its entirety.

### FIELD

The present invention relates to a network system and a resource allocation method thereof; and more particularly, the network system and the resource allocation method thereof averagely allocate network resources mainly by use of a common base station identification (ID) and a dedicated base station ID.

### BACKGROUND

In order to improve the communication quality of base stations in a conventional network system and to make the way in which mobile stations connect with the base stations more flexible, application of micro base stations (e.g., the small cell base stations of 3GPP networks) has been developed correspondingly. Specifically, the main idea is to enlarge the channel capacity by deploying a lot of base stations that have a lower computing power than common base stations but have the benefit of a lower cost so that the flexibility of communication between the mobile stations and the base stations is increased.

However, although deployment of a lot of base stations helps to increase the flexibility of communication between the mobile stations and the base stations, the overlaps between communication coverages of the individual base stations increase correspondingly as the number of base stations increases due to the nature of the existing network communication protocols for micro base stations. Therefore, when a mobile station moves into an overlapped region between the communication coverages, the communication interference suffered by the mobile station will be increased greatly. Moreover, as the number of base stations increases, both the frequency and complexity of handovers caused when the mobile station moves quickly between the base stations increase correspondingly. As a consequence, the increased number of base stations does not lead to a corresponding increase in the network communication quality, and the computational burden of the network as a whole becomes greater.

Accordingly, an urgent need exists in the art to provide a solution that can mitigate the communication interference suffered by the mobile station and reduce the handover frequency and complexity in the network system as the number of base stations increases.

### SUMMARY

A primary objective of certain embodiments of the present invention includes providing a resource allocation method for a network system. The network system comprises a base station and a mobile station. The resource allocation method according to certain embodiments comprises: (a) enabling the base station to retrieve mobile station information from the mobile station via a network connection; (b) enabling the base station to decide a communication allocation between the base station and the mobile station according to the mobile station information, where the communication allocation records one or a combination of a common base station identification (ID) and a dedicated base station ID of the base station; (c) enabling the base station to transmit the communication allocation to the mobile station; and (d) enabling the mobile station to communicate with the base station via one or a combination of the common base station ID and the dedicated base station ID according to the communication allocation.

To achieve the aforesaid objective, certain embodiments of the present invention further include a network system, which comprises a base station and a mobile station. The base station in certain embodiments is configured to retrieve mobile station information from the mobile station via the network connection, and decide a communication allocation between the base station and the mobile station according to the mobile station information. The communication allocation records one or a combination of a common base station ID and a dedicated base station ID of the base station. The base station is further configured to transmit the communication allocation to the mobile station. The mobile station is configured to communicate with the base station via one or a combination of the common base station ID and the dedicated base station ID according to the communication allocation.

To achieve the aforesaid objective, certain embodiments of the present invention further include a resource allocation method for a base station. The base station is for use in a network system, and the network system further comprises a mobile station. The resource allocation method in certain embodiments comprises: (a) enabling the base station to retrieve mobile station information from the mobile station via a network connection; (b) enabling the base station to decide a communication allocation between the base station and the mobile station according to the mobile station information, where the communication allocation records one or a combination of a common base station ID and a dedicated base station ID of the base station; (c) enabling the base station to transmit the communication allocation to the mobile station so that the mobile station connects with the base station according to the communication allocation; and (d) enabling the base station to communicate with the mobile station via one or a combination of the common base station ID and the dedicated base station ID.

To achieve the aforesaid objective, certain embodiments of the present invention further include a base station for use in a network system. The network system in certain embodiments further comprises a mobile station. The base station comprises a transceiver and a processor. The transceiver is configured to connect with the mobile station via a network connection and retrieve mobile station information from the mobile station via the network connection. The processor is configured to decide a communication allocation between the base station and the mobile station according to the mobile station information. The communication allocation records one or a combination of a common base station ID and a dedicated base station ID of the base station. The transceiver is further configured to transmit the communication allocation to the mobile station so that the mobile station connects with the base station according to the communication allocation. The transceiver is further configured to communicate with the mobile station via one or a combination of the common base station ID and the dedicated base station ID.

To achieve the aforesaid objective, certain embodiments of the present invention further include a resource allocation method for a mobile station. The mobile station is for use in a network system. The network system in certain embodiments further comprises a base station. The resource allocation method comprises: (a) enabling the mobile station to transmit mobile station information to the base station via a network connection so that the base station decides a communication allocation between the base station and the mobile station according to the mobile station information, where the communication allocation records one or a combination of a common base station ID and a dedicated base station ID of the base station; (b) enabling the mobile station to receive the communication allocation from the base station; and (c) enabling the mobile station to communicate with the base station via one or a combination of the common base station ID and the dedicated base station ID according to the communication allocation.

To achieve the aforesaid objective, certain embodiments of the present invention further include a mobile station for use in a network system. The network system further comprises a base station. The mobile station comprises a transceiver and a processor. The transceiver in certain embodiments is configured to connect with the base station via a network connection and transmit mobile station information to the base station via the network connection so that the base station decides a communication allocation between the base station and the mobile station according to the mobile station information. The communication allocation records one or a combination of a common base station ID and a dedicated base station ID of the base station. The transceiver is further configured to receive the communication allocation from the base station, and the processor is further configured to analyze the network allocation so that the transceiver communicates with the base station via one or a combination of the common base station ID and the dedicated base station ID according to the communication allocation.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a network system according to a first embodiment of the present invention;

FIG. 1B is a block diagram of a mobile station according to the first embodiment of the present invention;

FIG. 1C is a block diagram of a base station according to the first embodiment of the present invention;

FIG. 2A-2B are a schematic view of a network system according to a second embodiment of the present invention;

FIGS. 3A-3B are schematic views of a network system according to a third embodiment of the present invention;

FIG. 4 is a schematic view of a network system according to a fourth embodiment of the present invention;

FIG. 5 is a schematic view of a network system according to a fifth embodiment of the present invention;

FIG. 6 is a schematic view of a network system according to a sixth embodiment of the present invention;

FIG. 7 is a schematic view of a network system according to a seventh embodiment of the present invention;

FIG. 8 is a schematic view of a resource allocation method according to an eighth embodiment of the present invention;

FIG. 9 is a schematic view of a resource allocation method according to a ninth embodiment of the present invention;

FIG. 10 is a flowchart diagram of a resource allocation method according to a tenth embodiment of the present invention;

FIG. 11 is a flowchart diagram of a resource allocation method according to an eleventh embodiment of the present invention; and.

### DETAILED DESCRIPTION

In the following description, the present invention will be explained with reference to example embodiments thereof. However, these example embodiments are not intended to limit the present invention to any specific examples, embodiments, environment, applications or particular implementations described in these embodiments. Therefore, description of these example embodiments is only for purpose of illustration rather than to limit the present invention. In the following embodiments and the attached drawings, elements unrelated to the present invention are omitted from depiction; and dimensional relationships among individual elements in the attached drawings are illustrated only for ease of understanding, but not to limit the actual scale.

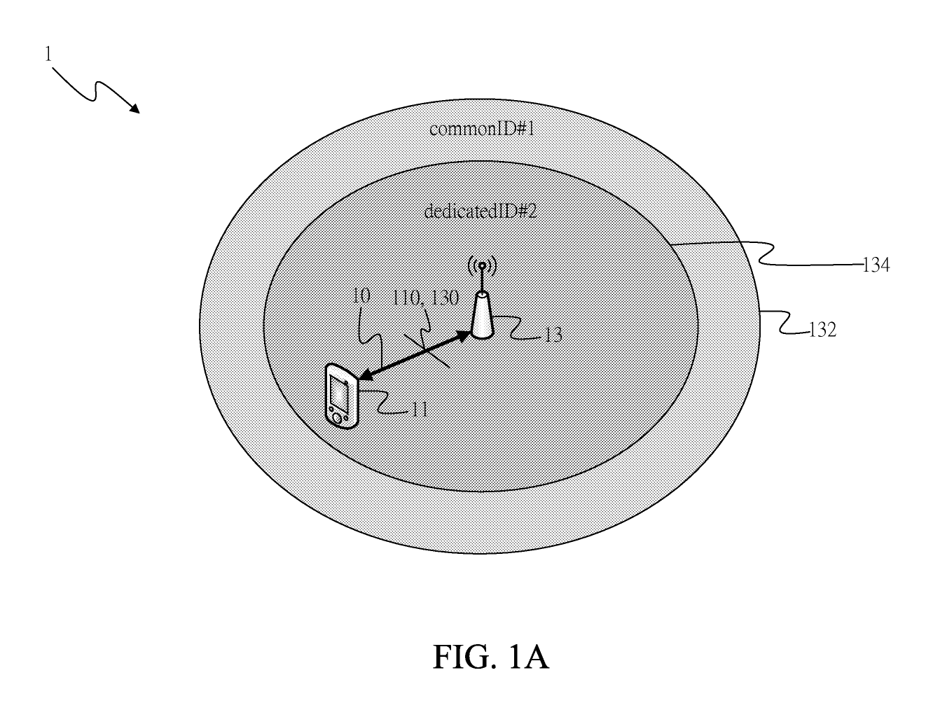

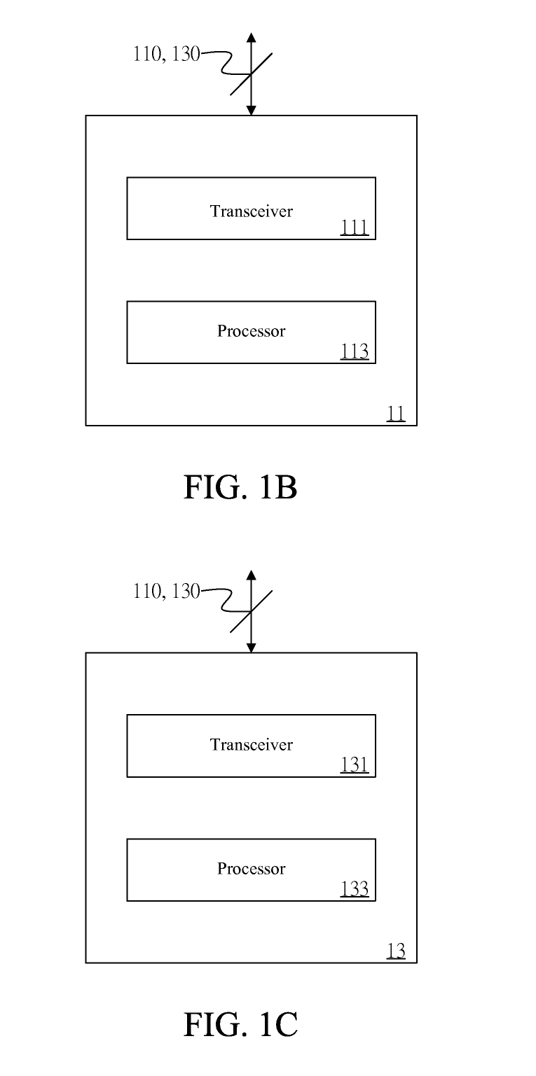

Please refer to FIG. 1A to FIG. 1C together. FIG. 1A is a schematic view of a network system 1 according to a first embodiment of the present invention. The network system 1 comprises a mobile station 11 and a base station 13. The mobile station 11 and the base station 13 have a network connection 10 therebetween. FIG. 1B is a block diagram of the mobile station 11 according to the present invention. The mobile station 11 comprises a transceiver 111 and a processor 113. FIG. 1C is a block diagram of the base station 13 according to the first embodiment. The base station 13 comprises a transceiver 131 and a processor 133. Interactions between the individual components will be further described hereinbelow.

Firstly, the base station 13 must determine the service utilization state of the mobile station 11 so as to determine in which way the network resources are to be provided. Specifically, the transceiver 131 of the base station 13 firstly retrieves mobile station information 110 from the mobile station 11 via the network connection 10. The mobile station information 110 may be provided by the mobile station 11 actively or detected by the base station 13.

Then, the processor 133 of the base station 13 can decide a communication allocation 130 between the base station 13 and the mobile station 11 according to the mobile station information 110. The communication allocation 130 records one of a common base station identification (ID) commonID#1 and a dedicated base station ID dedicatedID#2, or a combination of the common base station ID commonID#1 and the dedicated base station ID dedicatedID#2.

It shall be particularly appreciated that, in the network system 1, the common base station ID commonID#1 is also used commonly by all other base stations (as shown, there is a common base station coverage 132), while the dedicated base station ID dedicatedID#2 is used solely by the base station 13 (as shown, there is a dedicated base station coverage 134). Further speaking, after a communication way possibly needed between the mobile station 11 and the base station 13 is determined by the base station 13 according to the mobile station information 110, the base station 13 can decide whether the common base station ID commonID#1 or the dedicated base station ID dedicatedID#2 is used to communicate with the mobile station 11.

For example, if the mobile station 11 is a mobile device moving quickly, the base station 13 may preferably choose to use the common base station ID commonID#1 to communicate with the mobile station 11. Because all base stations in the network system 1 use the same common base station ID commonID#1 (i.e., the mobile station 11 will view all the base stations having the common base station ID commonID#1 as a single base station), the handover procedure between the different base stations can be omitted when the mobile station 11 moves quickly in the network system 1.

Additionally, if the mobile station 11 is a device that demands a high bandwidth, the base station 13 may preferably choose to use the dedicated base station ID dedicatedID#2 to communicate with the mobile station 11. Thus, the base station 13 can flexibly allocate idle bandwidth resources to the mobile station 11 via the dedicated base station ID dedicatedID#2 that is dedicatedly used between the base station 13 and the mobile station 11. It shall be particularly appreciated that, in case of a device that demands a high bandwidth, the mobile station 11 is not only able to communicate with the base station 13 via the dedicated base station ID dedicatedID#2, but can also communicate with the base station 13 via the common base station ID commonID#1 so as to utilize the network resources more flexibly.

Accordingly, after the communication allocation 130 is decided by the processor 133 of the base station 13, the transceiver 131 of the base station 13 transmits the communication allocation 130 to the mobile station 11. Then, the mobile station 11 can learn whether the transceiver 111 needs to communicate with the base station 13 via the common base station ID commonID#1, the dedicated base station ID dedicatedID#2 or a combination thereof by analyzing the communication allocation 130.

Further, in other network environment conditions, the mobile station 11 may also perform a handover procedure between the common base station ID commonID#1 and the dedicated base station ID dedicatedID#2 depending on its demand for network resources. As an example, if the mobile station 11 is located within the coverage of the common base station ID commonID#1 and is to request a high bandwidth from the base station 13, the mobile station 11 may handover from the common base station ID commonID#1 to the dedicated base station ID dedicatedID#2. Conversely, the mobile station 11 may also handover from the dedicated base station ID dedicatedID#2 to the common base station ID commonID#1.

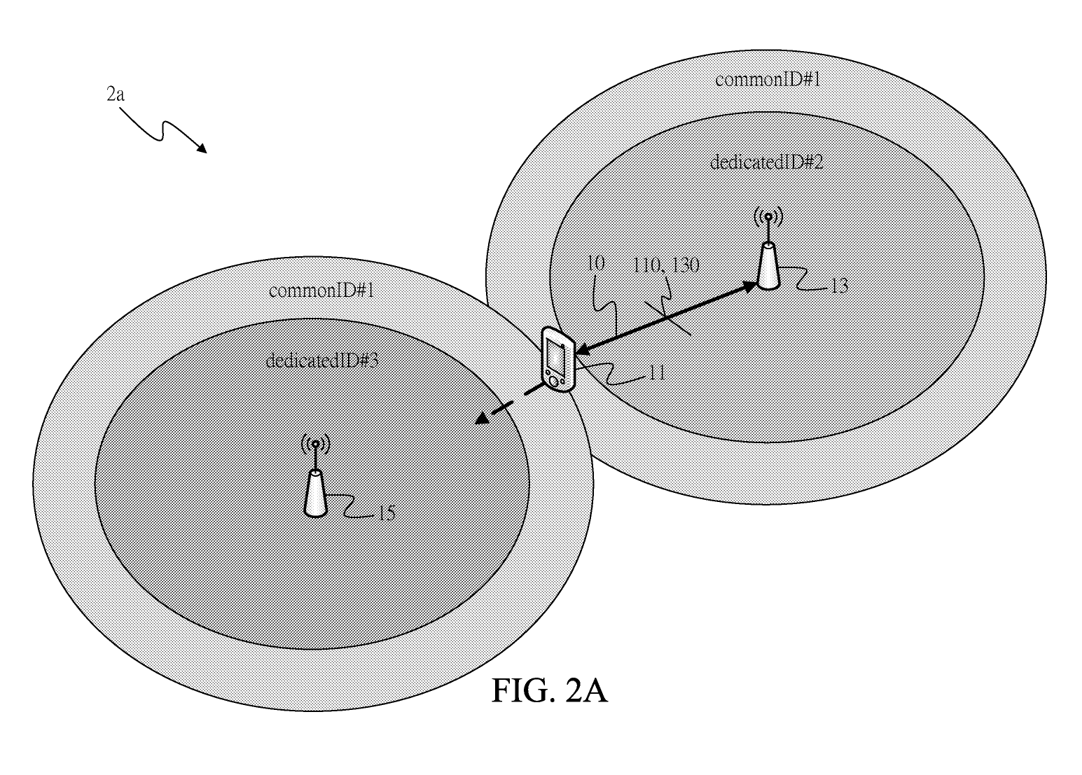

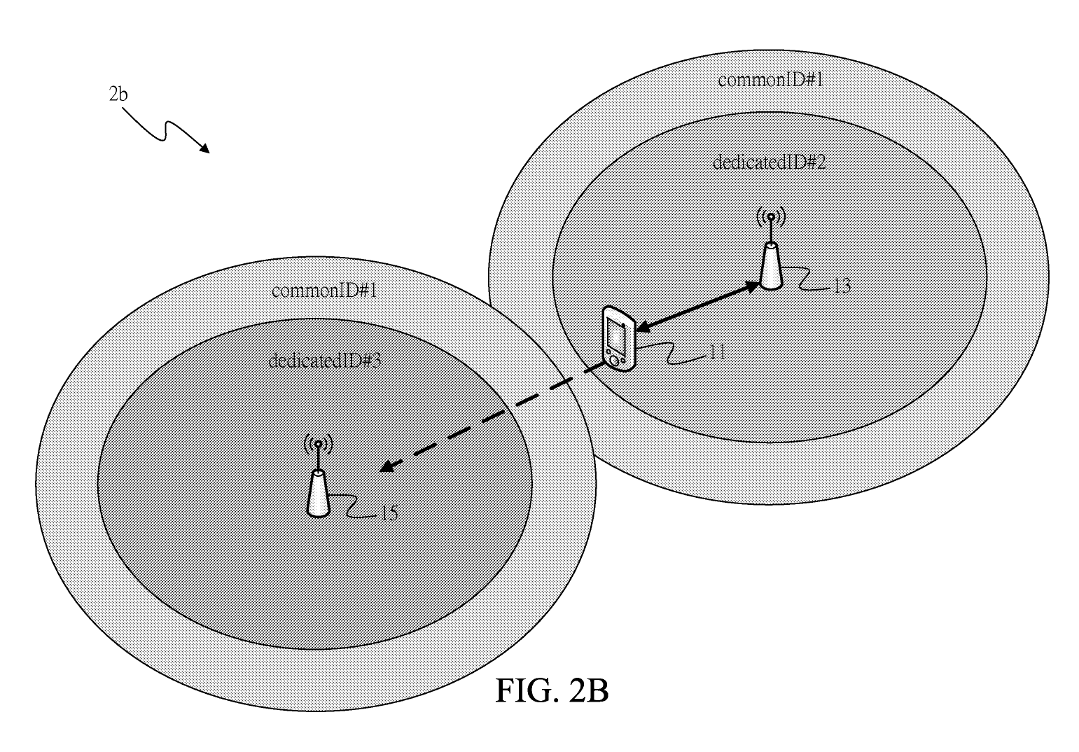

For purpose of providing a further understanding of the present invention, the present invention will be described hereinbelow with reference to various different operations. Referring to FIG. 2A, there is shown a schematic view of a network system 2a according to a second embodiment of the present invention. The network system 2a further comprises another base station 15. It shall be particularly appreciated that, the system architecture and the network connection environments of the second embodiment are identical to those of the previous embodiment, so components bearing the same reference symbols have the same functions and will not be further described herein.

In the second embodiment, the transceiver 131 of the base station 13 may further exchange the mobile station information 110 with the base station 15 via a backhaul network (not shown). Then, if related information of the mobile station 11 is available to a plurality of base stations, the base station 13 and the base station 15 can cooperate to decide the communication allocation 130 between the base station 13 and the mobile station 11 according to the mobile station information 110.

For example, if the mobile station 11 is to move quickly from the coverage of the base station 13 to the base station 15, the base station 13 and the base station 15 may preferably choose to use the common base station ID commonID#1 to communicate with the mobile station 11. In this case, because the different base stations (i.e., the base stations 13 and 15) are viewed by the mobile station 11 as a single base station when the mobile station 11 moves quickly in coverages of the two base stations, the handover procedure can be omitted.

Additionally, if the mobile station 11 is a device that demands a high bandwidth and is to move into the coverage of the base station 15, the base station 15 may preferably prepare a dedicated base station ID dedicatedID#3 to communicate with the mobile station 11. Thus, the base station 15 can flexibly allocate idle bandwidth resources to the mobile station 11 via the dedicated base station ID dedicatedID#2 that is dedicatedly used between the base station 15 and the mobile station 11.

It shall be particularly appreciated that, there may be another connection application aspect in the network environment of the second embodiment. Specifically, referring to the network system 2b shown in FIG. 2B, the mobile station 11 and the base station 13 communicates with each other via the dedicated base station ID dedicatedID#2. When the mobile station 11 is to handover from the dedicated base station ID dedicatedID#2 of the base station 13 to the dedicated base station ID dedicatedID#2 of the base station 15 that has the common base station ID commonID#1 as the base station 13, related operations such as notifying the aforesaid handover can be simplified to ease the handover burden.

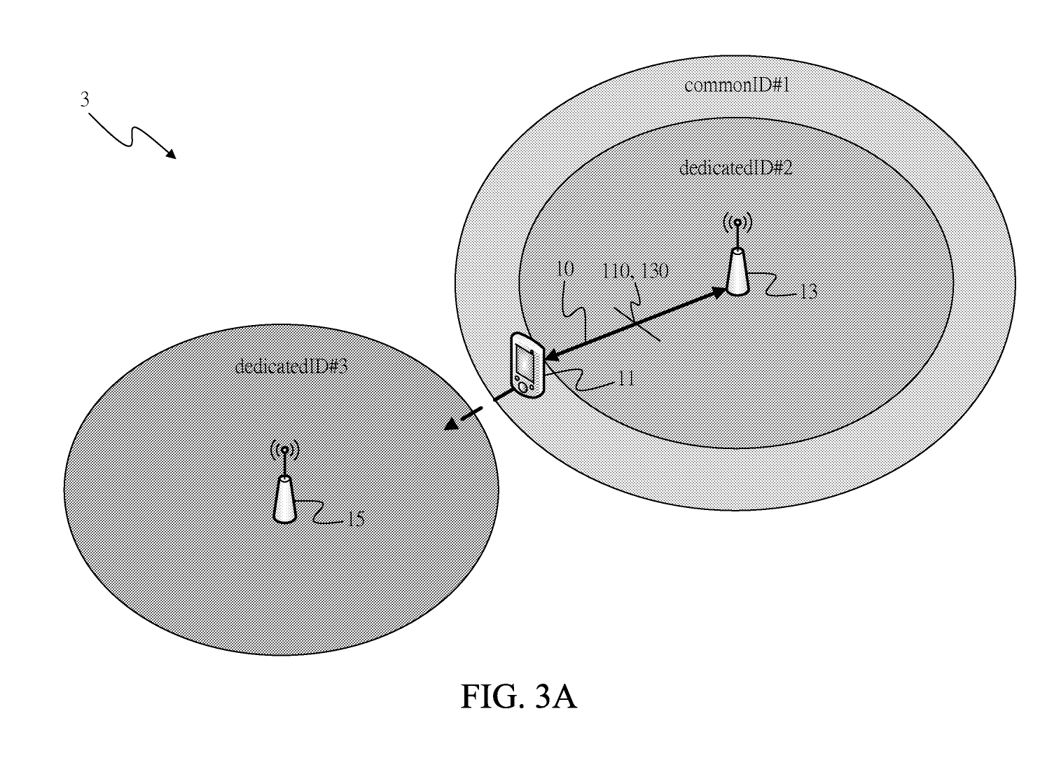

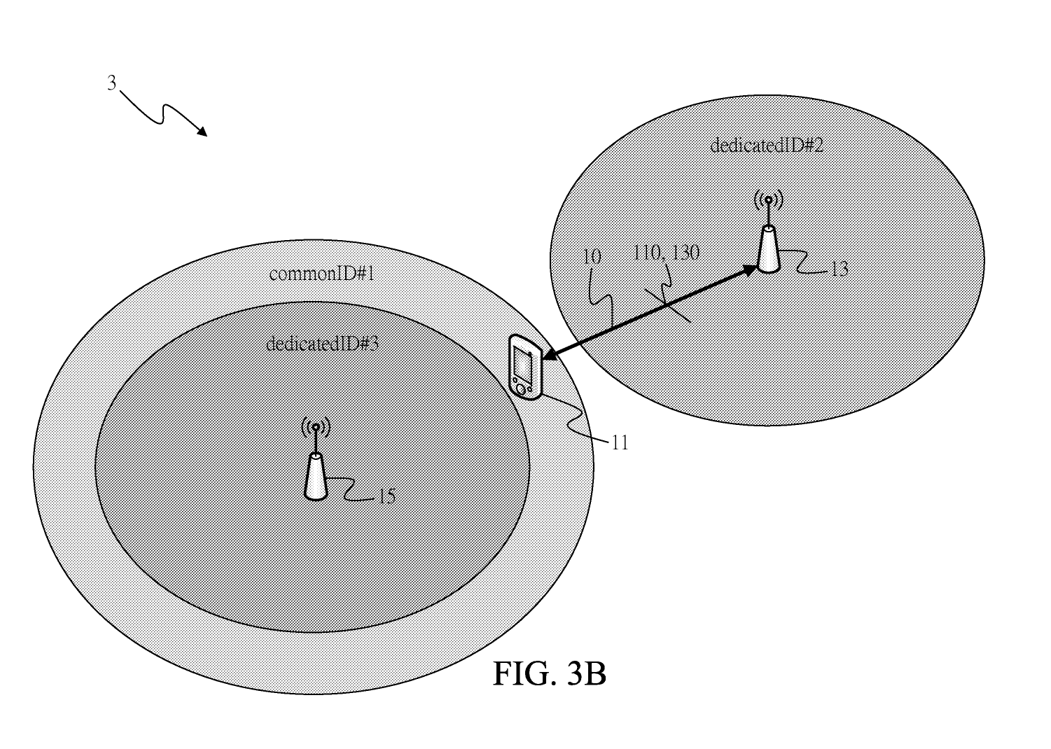

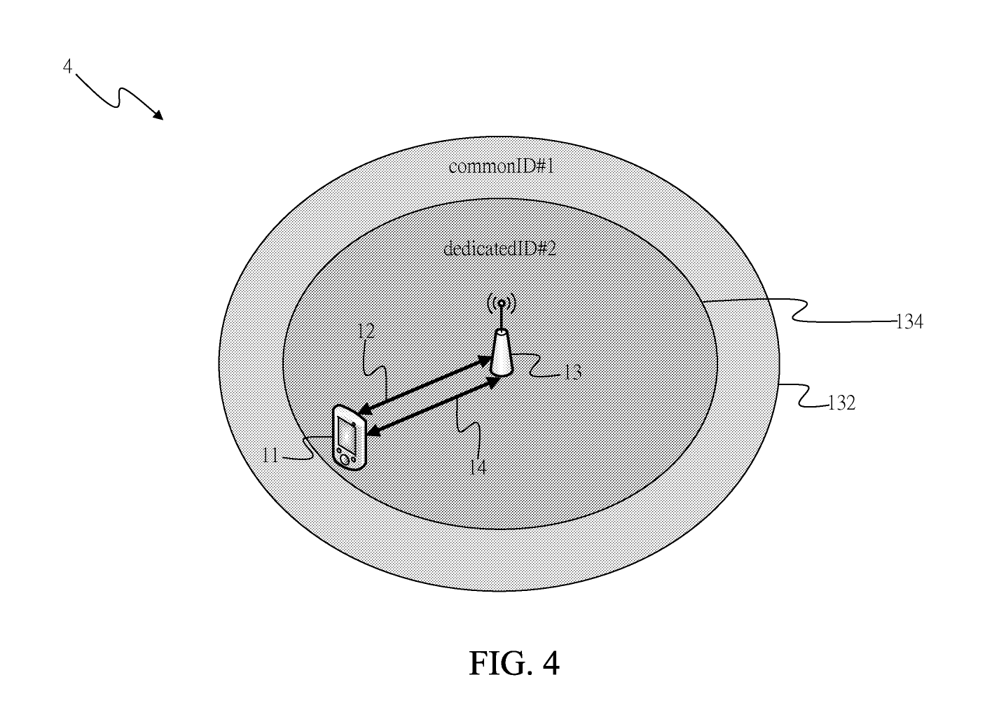

Referring to FIG. 3A and FIG. 3B, there are shown schematic views of a network system 3 according to a third embodiment of the present invention. It shall be particularly appreciated that, the network system 3 of the third embodiment is similar to the network system 2 of the second embodiment except for the switching between enabling and disabling of the common base station ID.

Specifically, in the network system 3 of the third embodiment, the base station 13 and the base station 15 also share the common base station ID commonID#1; however, in order to save use of the network resources, the base station 15 keeps the common base station ID commonID#1 disabled until the mobile station 11 moves into the coverage of the common base station ID commonID#1 of the base station 15.

Then, when the mobile station 11 moves from the coverage of the common base station ID commonID#1 of the base station 13 into the coverage of the common base station ID commonID#1 of the base station 15, the base station enables the common base station ID commonID#1 so that the mobile station 11 can accomplish the network connection with the base station directly via the common base station ID commonID#1. On the other hand, the base station 13 disables the common base station ID commonID#1 to save the network resources. It shall be particularly appreciated that, how to determine the communication coverage is just a conventional technology, so it will not be described herein.

It shall be particularly appreciated that, when a single connection is generated between the mobile station and the base station via the common base station ID or the dedicated base station ID in the network environment of the aforesaid embodiment, transmission of another ID may also be accomplished via the single connection between the mobile station and the base station. For example, when a single connection is generated between the mobile station 11 and the base station 13 via the common base station ID commonID#1, the mobile station 11 can not only communicate related information of the common base station ID commonID#1 with the base station 13 via the single connection, but also communicate related information of the dedicated base station ID dedicatedID#2 with the base station 13 via the single connection so that the dedicated base station ID dedicatedID#2 is directly available for subsequent use.

Referring to FIG. 4, there is shown a schematic view of a network system 4 according to a fourth embodiment of the present invention. It shall be particularly appreciated that, the network system 4 of the fourth embodiment is similar to the network system 1 of the first embodiment except that, in the fourth embodiment, a single mobile station can communicate with a base station in a dual link manner via the common base station ID and the dedicated base station ID simultaneously.

Specifically, because the common base station ID commonID#1 allows for a high flexibility in communication and the dedicated base station ID dedicatedID#2 allows for stable and high bandwidth communication, the mobile station 11 may communicate with the base station 13 via the common base station ID commonID#1 and the dedicated base station ID dedicatedID#2 of the base station 13 respectively by means of the network connections 12 and 14.

For example, because the downlink transmits a large amount of data and requires a higher bandwidth and the uplink needs not occupy too many network resources and has a higher flexibility in use, the mobile station 11 can use the network connection 12 that connects with the common base station ID commonID#1 to accomplish the uplink transmission and use the network connection 14 that connects with the dedicated base station ID dedicatedID#2 to accomplish the downlink transmission.

Similarly, if the network system 4 is an LTE or 3GPP network system, the user plane connection has to transmit a large amount of data and requires a higher bandwidth and, in contrast, the control plane connection that only has to transmit control signals need not occupy too many network resources and has a higher flexibility in use. Accordingly, the mobile station 11 can accomplish transmission of the control plane connection by means of the network connection 12 that connects with the common base station ID commonID#1, and accomplish transmission of the user plane connection by means of the network connection 14 that connects with the dedicated base station ID dedicatedID#2.

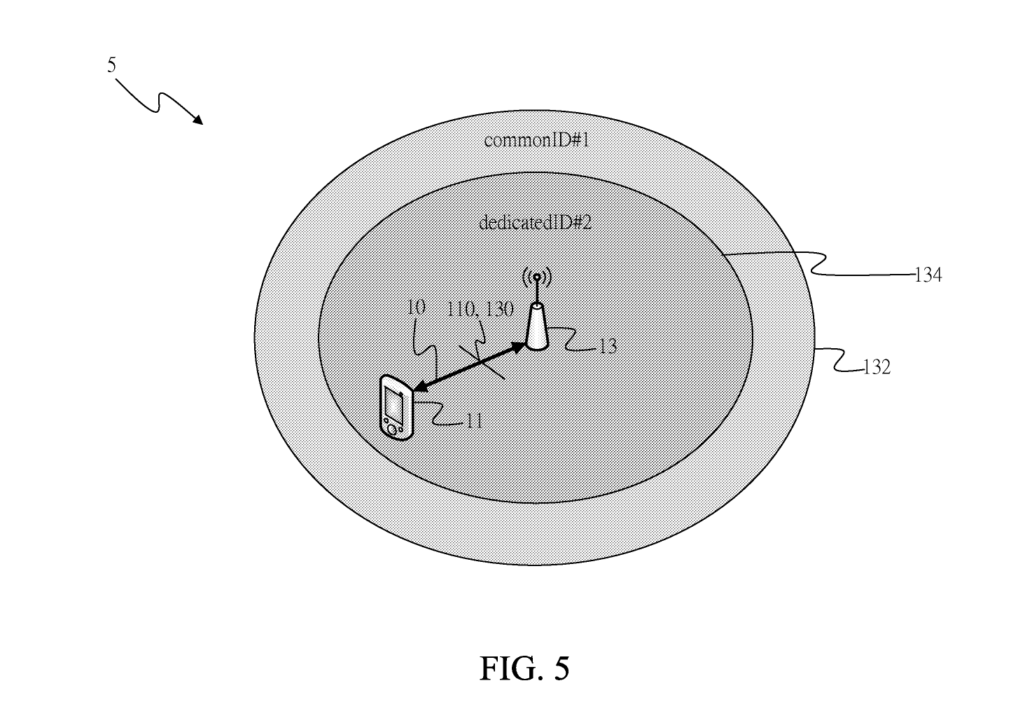

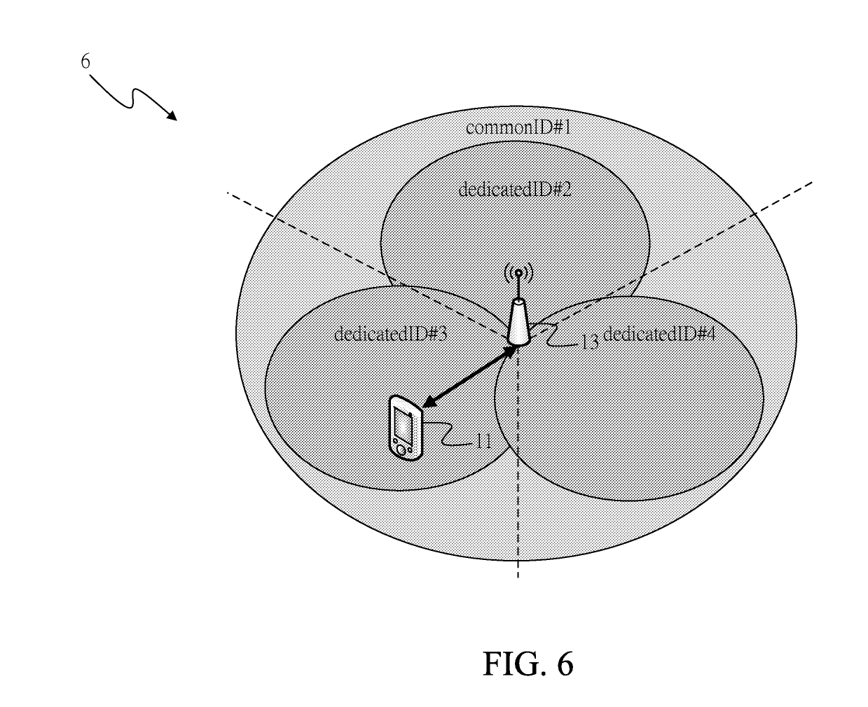

Referring to FIG. 5, there is shown a schematic view of a network system 5 according to a fifth embodiment of the present invention. Similarly, the system architecture and the network connection environment of the fifth embodiment are identical to those of the previous embodiments, so components bearing the same reference symbols have the same functions and will not be further described herein. The fifth embodiment mainly details the relationship between the mobile station information and the communication allocation.

Similarly, the base station 13 must firstly determine the service utilization state of the mobile station 11 so as to determine in which way the network resources are to be provided. Specifically, the transceiver 131 of the base station 13 firstly retrieves the mobile station information 110 from the mobile station 11 via the network connection 10. In the fifth embodiment, the mobile station information 110 comprises one or a combination of a mobile station movement speed (not shown, and may be provided by the mobile station 11 itself or measured by the base station 13), a mobile station interference value (not shown, and may be provided by the mobile station 11 itself or measured by the base station 13) and a mobile station bandwidth demand (not shown). The mobile station movement speed and the mobile station interference value may also be detected by the base station 13, and the mobile station bandwidth demand may be obtained from a message actively provided by the mobile station 11. Then, the processor 133 of the base station 13 decides the communication allocation 130 between the base station 13 and the mobile station 11 according to the mobile station movement speed, the mobile station interference value or the mobile station bandwidth demand comprised in the mobile station information 110.

It shall be particularly appreciated that, the mobile station information 110 is not limited to the mobile station movement speed, the mobile station interference value and the mobile station bandwidth demand, but may additionally comprise other related mobile station information such as the mobile station movement direction, the number of mobile station handovers, whether the mobile station is located within a coverage of a primary base station (e.g., a macrocell) and network system restrictions depending on the network environment and the user's needs.

In detail, if the processor 133 of the base station 13 determines that the mobile station movement speed of the mobile station information 110 exceeds a speed threshold (not shown), it means that the mobile station 11 is likely to move quickly in the network system 5 to cause a number of handover procedures. Accordingly, the processor 133 of the base station 13 may further enable the common base station ID commonID#1 of the base station 13 and decide the common base station coverage 132.

In this case, the communication allocation 130 records at least the common base station ID commonID#1 of the base station 13. Therefore, after the communication allocation 130 is transmitted by the transceiver 131 of the base station 13 to the mobile station 11, the processor 113 of the mobile station 11 can analyze the communication allocation 130 so that the transceiver 111 communicates with the base station 13 at least within the common base station coverage 132 via the common base station ID commonID#1. Because other base stations also use the same common base station ID commonID#1 and these base stations using the same common base station ID commonID#1 are viewed as a single base station by the mobile station 11, no handover procedure will take place.

Similarly, if the processor 133 of the base station 13 determines that the mobile station interference value of the mobile station information 110 exceeds an interference threshold (not shown), it means that the mobile station 11 is possibly located at a border between different base stations in the network system 5. Accordingly, the processor 133 of the base station 13 uses also the common base station ID commonID#1 of the base station 13 to solve the problem of interferences between the different base stations.

Likewise, the communication allocation 130 records at least the common base station ID commonID#1 of the base station 13 in this case. Therefore, after the communication allocation 130 is transmitted by the transceiver 131 of the base station 13 to the mobile station 11, the processor 113 of the mobile station 11 can analyze the communication allocation 130 so that the transceiver 111 communicates with the base station 13 at least within the common base station coverage 132 via the common base station ID commonID#1. Because other base stations also use the same common base station ID commonID#1 and these base stations using the same common base station ID commonID#1 are viewed as a single base station by the mobile station 11, no interference between base stations will take place.

If the processor 133 of the base station 13 determines that the mobile station bandwidth demand of the mobile station information 10 exceeds a bandwidth demand threshold (not shown), it means that the mobile station 11 is likely to demand a stable data transmission connection in the network system 5. Accordingly, the processor 133 of the base station 13 may further enable the dedicated base station ID dedicatedID#2 of the base station 13 and decide a dedicated base station coverage 134.

In this case, the communication allocation 130 records at least the dedicated base station ID dedicatedID#2 of the base station 13. Therefore, after the transceiver 131 of the base station 13 further transmits the communication allocation 130 to the mobile station 11, the communication allocation 130 can be analyzed by the processor 113 of the mobile station 11 so that the transceiver 111 communicate with the base station 13 at least within the dedicated base station coverage 134 via the dedicated base station ID dedicatedID#2 to improve the transmission stability of the traffic data.

It shall be particularly appreciated that, it is possible that the mobile station 11 satisfies the aforesaid determination results simultaneously, so the base station 13 can decide whether the communication allocation 130 shall record enabling or disabling of the common base station ID commonID#1 and the dedicated base station ID dedicatedID#2 of the base station 13 with respect to different contents of the mobile station information 110.

It shall be particularly appreciated that, the description of the aforesaid embodiments are not intended to limit the number of the common base station ID(s) and the dedicated base station ID(s) that are used, and on the basis of the present inventive concept, the number of the common base station ID(s) and the dedicated base station ID(s) that are used may be increased or decreased depending on the network environment. This will be described with reference to different exemplary examples hereinbelow.

Referring to FIG. 6, there is shown a schematic view of a network system 6 according to a sixth embodiment of the present invention. It shall be particularly appreciated that, the network system 6 of the sixth embodiment is similar to the network system 1 of the first embodiment except that: in the sixth embodiment, a same base station 13 can allocate one common base station ID commonID#1 and a plurality of dedicated base station IDs dedicatedID#2, dedicatedID#3, dedicatedID#4 corresponding to different communication directivities simultaneously depending on the network service environment. Thus, further resource management and allocation can be accomplished on mobile stations having different directivities.

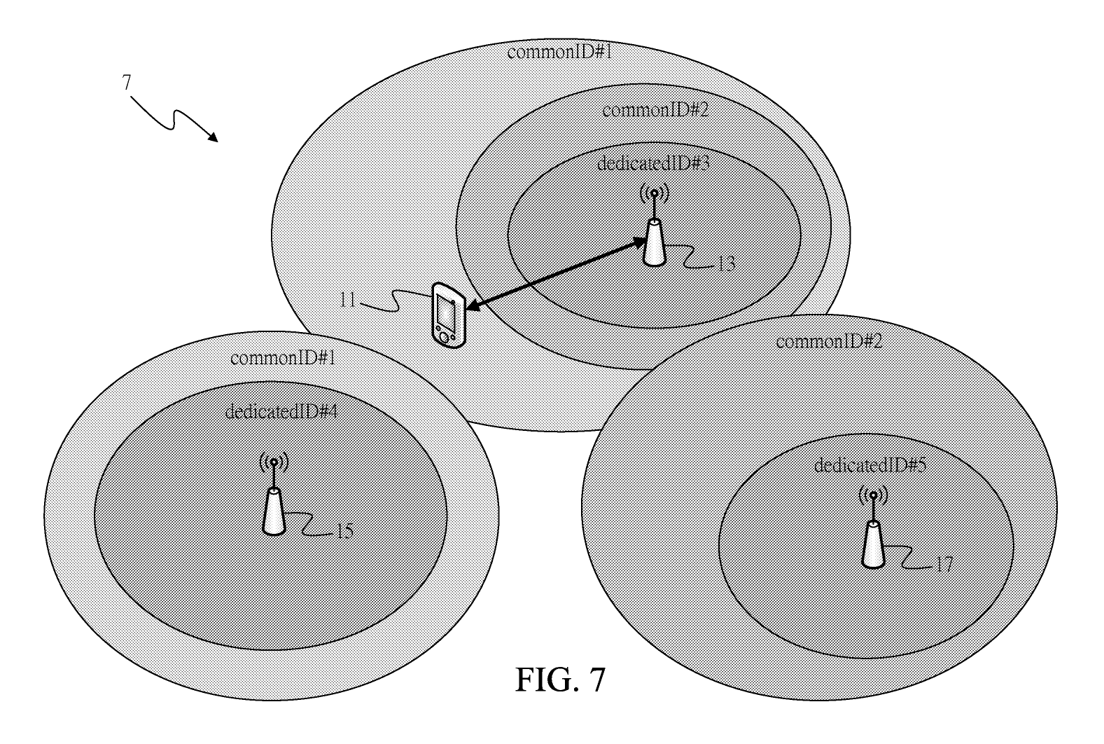

Referring to FIG. 7, there is shown a schematic view of a network system 7 according to a seventh embodiment of the present invention. The network system 7 further comprises a base station 17. It shall be particularly appreciated that, the network system 7 of the seventh embodiment is similar to that of the aforesaid embodiments except that: in the seventh embodiment, the base station can allocate a plurality of common base station IDs and a plurality of dedicated base station IDs simultaneously depending on the network environment demands.

In detail, as shown, the base station 13 shares a common base station ID commonID#1 and a common base station ID commonID#2 with the base station 15 and the base station 17 respectively; and meanwhile, the base station 13 has a dedicated base station ID dedicatedID#3; the base station 15 has a dedicated base station ID dedicatedID#4, and the base station 17 has a dedicated base station ID dedicatedID#5. In this way, the mobile station can communicate with the base stations in the network system 7 more efficiently and flexibly.

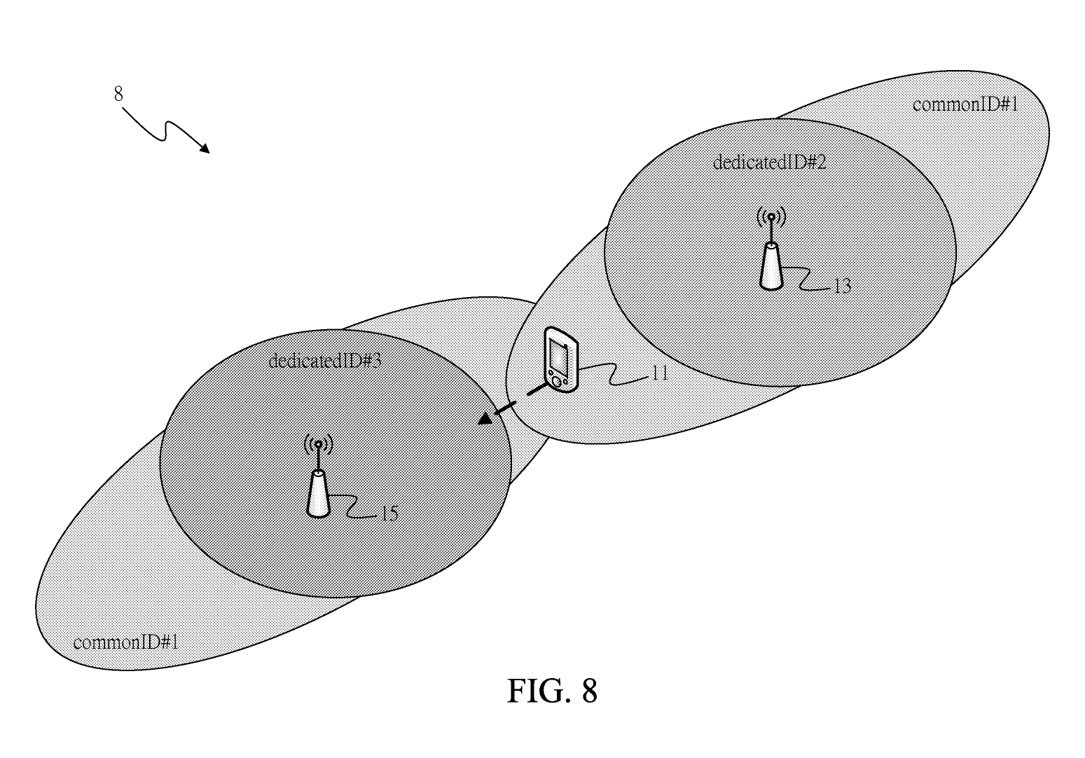

Referring to FIG. 8, there is shown a schematic view of a network system 8 according to an eighth embodiment of the present invention. It shall be particularly appreciated that, the network system 8 of the eighth embodiment is similar to the network system 2 of the second embodiment except for the coverage and the range of the common base station ID.

Specifically, the base station 13 and the base station 15 in the network system 8 of the eighth embodiment can correspondingly adjust the coverage of the common base station ID commonID#1 depending on the environment demands by means of the antenna directivity and the base station transmitting power (as shown). Thus, if the mobile station 11 moves along a straight route, the base station can adjust the coverage of the common base station ID commonID#1 according to the direction of the straight route so that the common base station ID commonID#1 can be utilized by the mobile station 11 more efficiently.

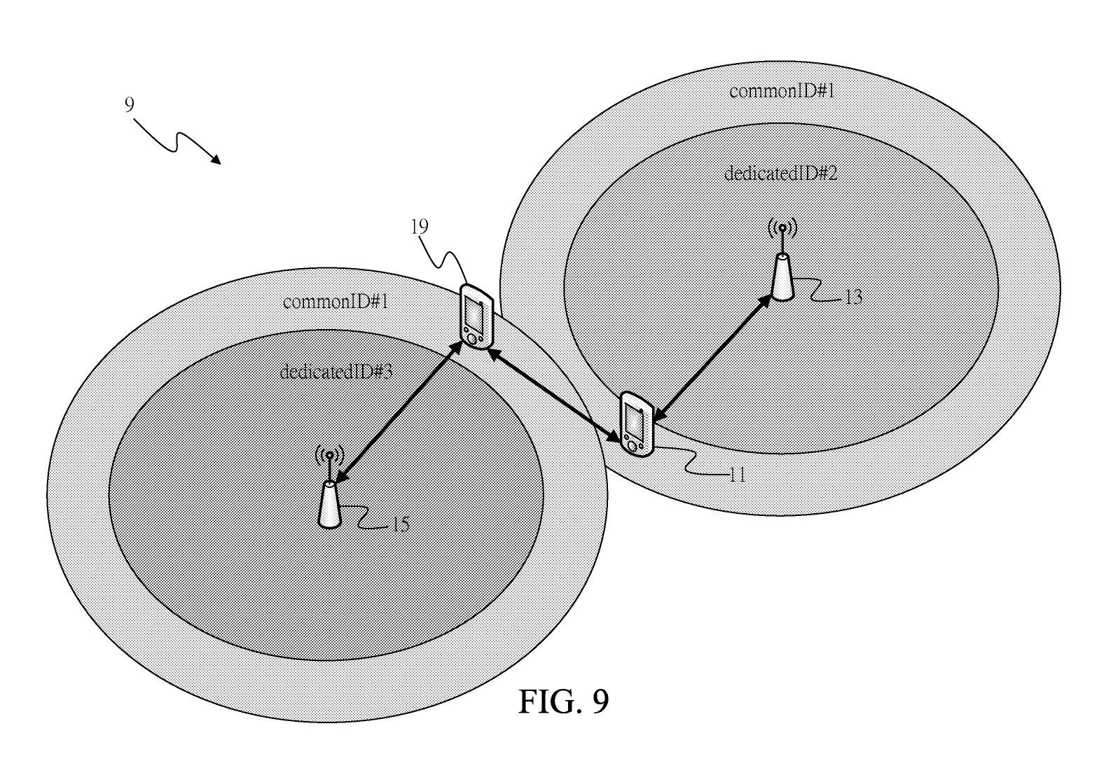

Referring to FIG. 9, there is shown a schematic view of a network system 9 according to a ninth embodiment of the present invention. It shall be particularly appreciated that, the network system 9 of the ninth embodiment is similar to the network system 2 of the second embodiment except that the network system 9 further comprises a mobile station 19.

Specifically, the mobile station 19 and the mobile station 11 have a direct communication connection therebetween in the network system 9 of the ninth embodiment. Thus, even when the mobile station 11 and the mobile station 19 connect with different base stations 13 and 15 respectively, the mobile station 11 and the mobile station 19 can still share the network resources by use of the technology and mechanism of the present invention because the base station 13 and the base station 15 have the same common base station ID commonID#1. In this way, the connection burden of the direct communication is eased.

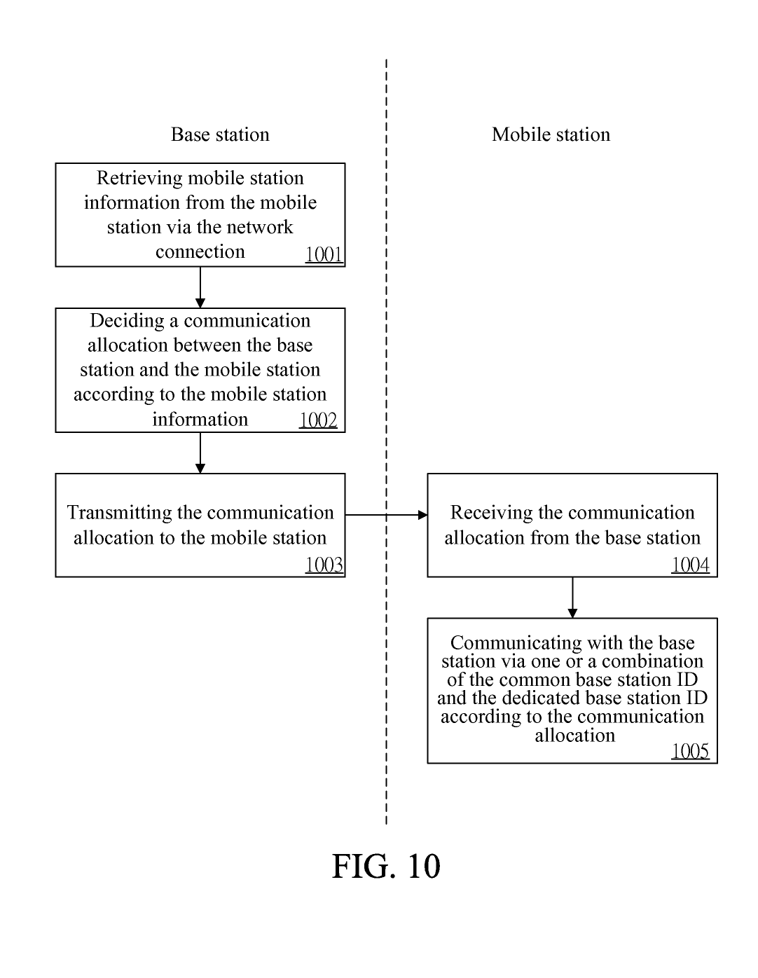

A tenth embodiment of the present invention is a resource allocation method, a flowchart diagram of which is shown in FIG. 10. The method of the tenth embodiment is for use in a network system as well as a base station and a mobile station comprised in the network system (e.g., the mobile station 11 and the base station 13 of the aforesaid embodiments). Detailed steps of the tenth embodiment will be described as follows.

Firstly, step 1001 is executed to enable the base station to retrieve mobile station information from the mobile station via a network connection. In other words, the mobile station transmits the mobile station information to the base station or the base station actively measures related information of the mobile station. Then, step 1002 is executed to enable the base station to decide a communication allocation between the base station and the mobile station according to the mobile station information. The communication allocation records one or a combination of a common base station ID and a dedicated base station ID of the base station, the common base station ID is commonly used by all base stations of the network system and the dedicated base station ID is used solely by the base station. Next, step 1003 is executed to enable the base station to transmit the communication allocation to the mobile station.

Afterwards, step 1004 is executed to enable the mobile station to receive the communication allocation from the base station, and step 1005 is executed to enable the mobile station to communicate with the base station via one or a combination of the common base station ID and the dedicated base station ID according to the communication allocation. It shall be particularly appreciated that, in the step 1002, the base station may further exchange the mobile station information with another base station in the network system; and then cooperate with the another base station to decide the communication allocation between the base station and the mobile station; and in the step 1004, the mobile station may further communicate with the base station in a dual link manner via the common base station ID and the dedicated base station ID simultaneously according to the communication allocation.

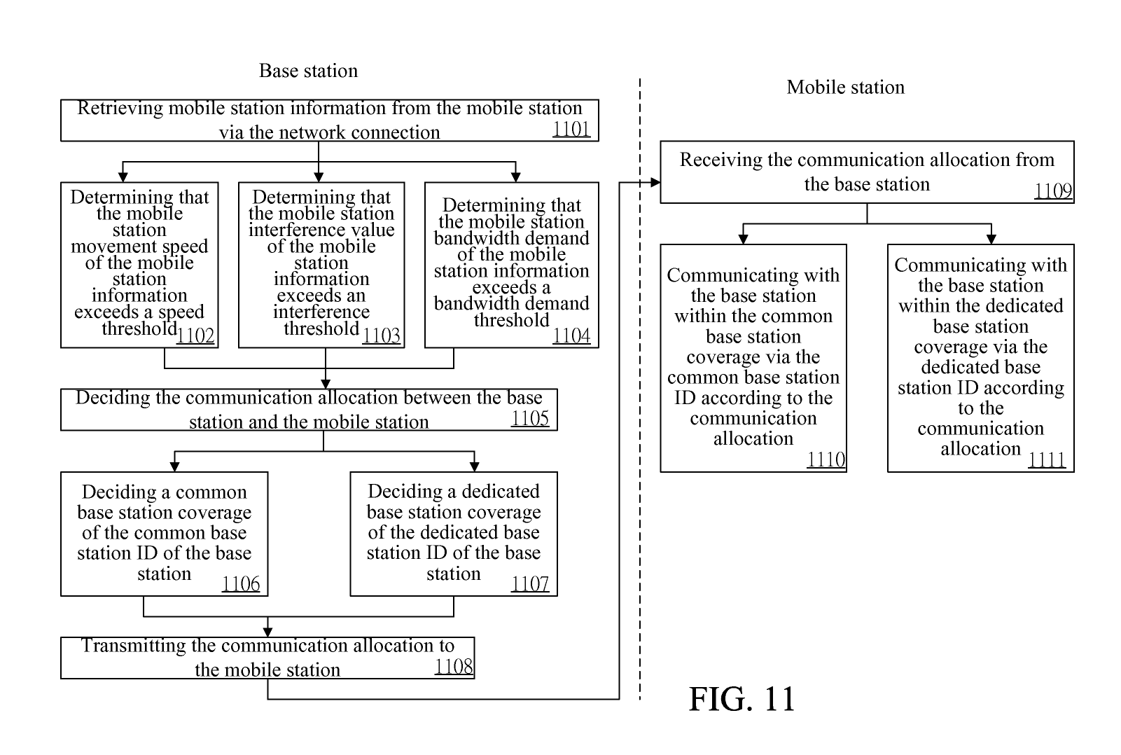

An eleventh embodiment of the present invention is a resource allocation method, a flowchart diagram of which is shown in FIG. 11. The method of the eleventh embodiment is for use in a network system as well as a base station and a mobile station comprised in the network system (e.g., the mobile station 11 and the base station 13 of the aforesaid embodiments). Detailed steps of the eleventh embodiment will be described as follows.

Firstly, step 1101 is executed to enable the base station to retrieve mobile station information from the mobile station via a network connection. In other words, the mobile station transmits the mobile station information to the base station. The mobile station information comprises one or a combination of a mobile station movement speed, a mobile station interference value and a mobile station bandwidth demand.

Then, step 1102 is executed to enabling the base station to determine that the mobile station movement speed of the mobile station information exceeds a speed threshold. This means that the mobile station is a device that moves quickly, and a number of handovers are likely to take place between different base stations. Accordingly, step 1105 is executed to enable the base station to decide the communication allocation between the base station and the mobile station, and step 1106 is executed to enable the base station to decide a common base station coverage of the common base station ID.

Next, step 1108 is executed to enable the base station to transmit the communication allocation to the mobile station, and step 1109 is executed to enable the mobile station to receive the communication allocation from the base station. Afterwards, step 1110 is executed to enable the mobile station to communicate with the base station within the common base station coverage via the common base station ID according to the communication allocation.

On the other hand, step 1103 may also be executed after the step 1101 to enable the base station to determine that the mobile station interference value of the mobile station information exceeds an interference threshold. This means that the mobile station is possibly located at a boarder between different base stations. Then, the steps 1105, 1106, 1108, 1109 and 1110 are executed in a similar way.

Furthermore, step 1104 may also be executed after the step 1101 to enable the base station to determine that the mobile station bandwidth demand of the mobile station information exceeds a bandwidth demand threshold. Then, step 1105 is executed to enable the base station to decide the communication allocation between the base station and the mobile station; and one or both of the steps 1106 and 1107 are executed to enable the base station to decide a common base station coverage of the common base station ID of the base station and a dedicated base station coverage of the dedicated base station ID of the base station.

Afterwards, the step 1108 is executed to enable the base station to transmit the communication allocation to the mobile station, and step 1109 is executed to enable the mobile station to receive the communication allocation from the base station. Then, one or both of the steps 1110, 1111 are executed to enable the mobile station to communicate with the base station within the common base station coverage via the common base station ID or within the dedicated base station coverage via the dedicated base station ID according to the communication allocation.

It shall be particularly emphasized that, when the mobile station receives the communication allocation from the base station in the aforesaid embodiments of the present invention, the mobile station can be synchronized with the base station at the same time via synchronization information appended by the base station in the communication allocation. Then, the mobile station may also transmit, by use of different preamble formats of the ranging message, a message back to notify the base station that the mobile station is to connect with the base station via the common base station ID or the dedicated base station ID. Thus, the base station can determine from the preamble the category of the ID used by the mobile station for connection and accomplish the corresponding random access and network connection procedures.

On the other hand, in order to improve the utilization efficiency or the security, the base station may define the way of accessing the common base station ID or the dedicated base station ID. Specifically, taking the common base station ID as an example, the base station may decide that the common base station ID thereof is accessed in an open way or a closed way. The open way allows the common base station ID to be accessed by any mobile station, while the closed way only allows the common base station ID to be accessed by mobile stations approved by the base station. Likewise, the dedicated base station ID may be used in the same mode.

Furthermore, the combination of the common base station ID and the dedicated base station ID may be achieved by carrying the dedicated base station ID in a common base station ID message or by carrying the common base station ID in a dedicated base station ID message. Thus, the mobile station can obtain both the common base station ID and the dedicated base station ID from the common base station ID message or the dedicated base station ID message when it receives the communication allocation from the base station.

In other application implementations, the sizes of network communication resource blocks corresponding to the common base station ID and the dedicated base station ID in the network system may be adjusted dynamically depending on the number of users (i.e., the number of mobile stations) in the network system or such demands as the transmission quality or the bandwidth so that a balance between the users and network resources of the network system is achieved. The resource may be adjusted by conventional network technologies such as Time Division Multiplexing (TDM), Frequency Division Multiplexing (FDM) or Code Division Multiplexing (CDM), which will not be described herein.

According to the above descriptions, the network system and the resource allocation method thereof according to the present invention allow for more efficient and proper communication between the mobile station and the base station by using the common base station ID and the dedicated base station ID alternately, thus making an improvement on the drawbacks of the prior art.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A resource allocation method for a network system, the network system comprising a base station and a mobile station, and the base station and the mobile station having a network connection therebetween, the resource allocation method comprising:
(a) enabling the base station to retrieve mobile station information from the mobile station via the network connection;
(b) enabling the base station to decide a communication allocation between the base station and the mobile station according to the mobile station information, wherein the communication allocation records one or a combination of a common base station identification (ID) and a dedicated base station ID of the base station, the common base station ID is commonly used by all base stations of the network system and the dedicated base station ID is used solely by the base station;
(c) enabling the base station to transmit the communication allocation to the mobile station; and
(d) enabling the mobile station to communicate with the base station via one or a combination of the common base station ID and the dedicated base station ID according to the communication allocation.

2. The resource allocation method as claimed in claim 1, wherein the step (b) further comprises:
(b1) enabling the base station to exchange the mobile station information with another base station; and
(b2) enabling the base station to cooperate with the another base station to decide the communication allocation between the base station and the mobile station according to the mobile station information.

3. The resource allocation method as claimed in claim 1, wherein the mobile station information comprises one or a combination of a mobile station movement speed, a mobile station interference value and a mobile station bandwidth demand.

4. The resource allocation method as claimed in claim 3, wherein the step (b) further comprises:
(b1) enabling the base station to determine that the mobile station movement speed of the mobile station information exceeds a speed threshold;
(b2) enabling the base station to decide the communication allocation between the base station and the mobile station according to the result of the step (b1); and
(b3) enabling the base station to decide a common base station coverage of the common base station ID of the base station after the step (b2);
and the step (d) further comprises:
(d1) enabling the mobile station to communicate with the base station within the common base station coverage via the common base station ID according to the communication allocation.

5. The resource allocation method as claimed in claim 3, wherein the step (b) further comprises:
(b1) enabling the base station to determine that the mobile station interference value of the mobile station information exceeds an interference threshold;
(b2) enabling the base station to decide the communication allocation between the base station and the mobile station according to the result of the step (b1); and
(b3) enabling the base station to decide a common base station coverage of the common base station ID of the base station after the step (b2);
and the step (d) further comprises:
(d1) enabling the mobile station to communicate with the base station within the common base station coverage via the common base station ID according to the communication allocation.

6. The resource allocation method as claimed in claim 3, wherein the step (b) further comprises:
(b1) enabling the base station to determine that the mobile station bandwidth demand of the mobile station information exceeds a bandwidth demand threshold;
(b2) enabling the base station to decide the communication allocation between the base station and the mobile station according to the result of the step (b1); and
(b3) enabling the base station to decide a common base station coverage of the common base station ID of the base station and a dedicated base station coverage of the dedicated base station ID of the base station after the step (b2);
and the step (d) further comprises:
(d1) enabling the mobile station to communicate with the base station within the common base station coverage via the common base station ID or within the dedicated base station coverage via the dedicated base station ID according to the communication allocation.

7. The resource allocation method as claimed in claim 1, wherein the step (d) further comprises:
(d1) enabling the mobile station to communicate with the base station in a dual link manner via the common base station ID and the dedicated base station ID simultaneously according to the communication allocation.

8. A network system, comprising:
a base station; and
a mobile station, having a network connection with the base station;
wherein the base station is configured to retrieve mobile station information from the mobile station via the network connection, and decide a communication allocation between the base station and the mobile station according to the mobile station information, the communication allocation records one or a combination of a common base station ID and a dedicated base station ID of the base station, the common base station ID is commonly used by all base stations of the network system and the dedicated base station ID is used solely by the base station, and the base station is further configured to transmit the communication allocation to the mobile station, and the mobile station is configured to communicate with the base station via one or a combination of the common base station ID and the dedicated base station ID according to the communication allocation.

9. A resource allocation method for a base station, the base station being for use in a network system, the network system further comprising a mobile station, and the base station and the mobile station having a network connection therebetween, the resource allocation method comprising:
(a) enabling the base station to retrieve mobile station information from the mobile station via the network connection;
(b) enabling the base station to decide a communication allocation between the base station and the mobile station according to the mobile station information, wherein the communication allocation records one or a combination of a common base station identification (ID) and a dedicated base station ID of the base station, the common base station ID is commonly used by all base stations of the network system and the dedicated base station ID is used solely by the base station;
(c) enabling the base station to transmit the communication allocation to the mobile station so that the mobile station connects with the base station according to the communication allocation; and
(d) enabling the base station to communicate with the mobile station via one or a combination of the common base station ID and the dedicated base station ID.

10. The resource allocation method as claimed in claim 9, wherein the step (b) further comprises:
(b1) enabling the base station to exchange the mobile station information with another base station; and
(b2) enabling the base station to cooperate with the another base station to decide the communication allocation between the base station and the mobile station according to the mobile station information.

11. The resource allocation method as claimed in claim 9, wherein the mobile station information comprises one or a combination of a mobile station movement speed, a mobile station interference value and a mobile station bandwidth demand.

12. The resource allocation method as claimed in claim 11, wherein the step (b) further comprises:
(b1) enabling the base station to determine that the mobile station movement speed of the mobile station information exceeds a speed threshold;
(b2) enabling the base station to decide the communication allocation between the base station and the mobile station according to the result of the step (b1); and
(b3) enabling the base station to decide a common base station coverage of the common base station ID of the base station after the step (b2);
and the step (d) further comprises:
(d1) enabling the base station to communicate with the mobile station within the common base station coverage via the common base station ID.

13. The resource allocation method as claimed in claim 11, wherein the step (b) further comprises:
(b1) enabling the base station to determine that the mobile station interference value of the mobile station information exceeds an interference threshold;
(b2) enabling the base station to decide the communication allocation between the base station and the mobile station according to the result of the step (b1); and
(b3) enabling the base station to decide a common base station coverage of the common base station ID of the base station after the step (b2);
and the step (d) further comprises:
(d1) enabling the base station to communicate with the mobile station within the common base station coverage via the common base station ID.

14. The resource allocation method as claimed in claim 11, wherein the step (b) further comprises:
(b1) enabling the base station to determine that the mobile station bandwidth demand of the mobile station information exceeds a bandwidth demand threshold;
(b2) enabling the base station to decide the communication allocation between the base station and the mobile station according to the result of the step (b1); and
(b3) enabling the base station to decide a common base station coverage of the common base station ID of the base station and a dedicated base station coverage of the dedicated base station ID of the base station after the step (b2);
and the step (d) further comprises:
(d1) enabling the base station to communicate with the mobile station within the common base station coverage via the common base station ID or within the dedicated base station coverage via the dedicated base station ID.

15. The resource allocation method as claimed in claim 9, wherein the step (d) further comprises:
(d1) enabling the base station to communicate with the mobile station in a dual link manner via the common base station ID and the dedicated base station ID simultaneously.

16. A base station for use in a network system, the network system further comprising a mobile station, the base station comprising:
a transceiver, being configured to connect with the mobile station via a network connection and retrieve mobile station information from the mobile station via the network connection; and
a processor, being configured to decide a communication allocation between the base station and the mobile station according to the mobile station information, wherein the communication allocation records one or a combination of a common base station ID and a dedicated base station ID of the base station, the common base station ID is commonly used by all base stations of the network system and the dedicated base station ID is used solely by the base station;
wherein the transceiver is further configured to transmit the communication allocation to the mobile station so that the mobile station connects with the base station according to the communication allocation, and the transceiver is configured to communicate with the mobile station via one or a combination of the common base station ID and the dedicated base station ID.

17. A resource allocation method for a mobile station, the mobile station being for use in a network system, the network system further comprising a base station, and the base station and the mobile station having a network connection therebetween, the resource allocation method comprising:
(a) enabling the mobile station to transmit mobile station information to the base station via the network connection so that the base station decides a communication allocation between the base station and the mobile station according to the mobile station information, wherein the communication allocation records one or a combination of a common base station ID and a dedicated base station ID of the base station, the common base station ID is commonly used by all base stations of the network system and the dedicated base station ID is used solely by the base station;
(b) enabling the mobile station to receive the communication allocation from the base station; and
(c) enabling the mobile station to communicate with the base station via one or a combination of the common base station ID and the dedicated base station ID according to the communication allocation.

18. The resource allocation method as claimed in claim 17, wherein the mobile station information comprises one or a combination of a mobile station movement speed, a mobile station interference value and a mobile station bandwidth demand.

19. The resource allocation method as claimed in claim 18, wherein after the base station determines that the mobile station movement speed of the mobile station information exceeds a speed threshold and, according to this, decides the communication allocation between the base station and the mobile station and a common base station coverage of the common base station ID, the step (d) further comprises:
(d1) enabling the mobile station to communicate with the base station within the common base station coverage via the common base station ID according to the communication allocation.

20. The resource allocation method as claimed in claim 18, wherein after the base station determines that the mobile station interference value of the mobile station information exceeds an interference threshold and, according to this, decides the communication allocation between the base station and the mobile station and a common base station coverage of the common base station ID, the step (d) further comprises:
(d1) enabling the mobile station to communicate with the base station within the common base station coverage via the common base station ID according to the communication allocation.

21. The resource allocation method as claimed in claim 18, wherein after the base station determines that the mobile station bandwidth demand of the mobile station information exceeds a bandwidth demand threshold and, according to this, decides the communication allocation between the base station and the mobile station as well as a common base station coverage of the common base station ID and a dedicated base station coverage of the dedicated base station ID of the base station, the step (d) further comprises:
(d1) enabling the mobile station to communicate with the base station within the common base station coverage via the common base station ID or within the dedicated base station coverage via the dedicated base station ID according to the communication allocation.

22. The resource allocation method as claimed in claim 17, wherein the step (d) further comprises:
(d1) enabling the mobile station to communicate with the base station in a dual link manner via the common base station ID and the dedicated base station ID simultaneously according to the communication allocation.

23. A mobile station for use in a network system, the network system further comprising a base station, the mobile station comprising:
a transceiver, being configured to connect with the base station via a network connection and transmit mobile station information to the base station via the network connection so that the base station decides a communication allocation between the base station and the mobile station according to the mobile station information, wherein the communication allocation records one or a combination of a common base station ID and a dedicated base station ID of the base station, the common base station ID is commonly used by all base stations of the network system and the dedicated base station ID is used solely by the base station; and
a processor;
wherein the transceiver is further configured to receive the communication allocation from the base station, and the processor is further configured to analyze the network allocation so that the transceiver communicates with the base station via one or a combination of the common base station ID and the dedicated base station ID according to the communication allocation.
